(19) United States
(12) Patent Application Publication
(10) Pub. No.: US 2014/0126192 A1
(43) Pub. Date: May 8, 2014

(54) WORKLIGHT WITH INTEGRATED CLAMP HANDLE

(71) Applicant: BLACKBEAM LLC, New York, NY (US)

(72) Inventors: Bruce ANCONA, New York, NY (US); Louis F. HENRY, Scarsdale, NY (US); Chris MELLEN, New York, NY (US)

(21) Appl. No.: 14/076,056

(22) Filed: Nov. 8, 2013

Related U.S. Application Data
(60) Provisional application No. 61/724,251, filed on Nov. 8, 2012.

(51) Int. Cl. F21V 21/088; F21L 4/04; F21V 21/30

(52) U.S. Cl. CPC F21V 21/0885; F21V 21/30; F21L 4/04
USPC 362/191; 362/396; 362/249.1

(57) ABSTRACT

The present disclosure provides a worklight having a handle with a clamp integrated therein, so that the worklight can be affixed to an object for hands free mode, or used portably. The worklight has a head that pivots and rotates with respect to the handle, so that it can be placed in a variety of positions. The worklight can be battery powered or powered by an external power source.

### CROSS-REFERENCE TO RELATED APPLICATION

The present application claims priority to U.S. Provisional Patent Application No. 61/724251, filed on Nov. 8, 2012, which is herein incorporated by reference.

### BACKGROUND OF THE DISCLOSURE

1. Field of the Disclosure

The present disclosure relates to worklights having handles that have a clamp integrated therein, and heads that can be placed in a variety of positions.

2. Background

There is a significant need among users of flashlights and worklights to have some sort of “hands-free” capability and flexibility in mounting options. Many currently available worklights have a simple hook or other device to hang the light on a hook or pole. This is very limiting in that the light can only be hung from a limited number of surfaces, and doesn't allow for flexible positioning of the light. In addition, the light portion of currently available worklights is usually fixed in place, so there is no ability to adjust the direction the light faces.

Accordingly, there is a need for a worklight that can provide hands-free operation for a user by mounting to a variety of surfaces, while simultaneously providing a portable capability.

### SUMMARY OF THE DISCLOSURE

In one embodiment, the present disclosure provides a worklight, comprising: a head, the head comprising a casing and a light source within the casing; a support member, wherein the head is rotatably connected to the mount; and a clamp having one end rotatably connected to the mount, and an opposite end having a gripping portion.

### BRIEF DESCRIPTION OF THE DRAWING

FIG. 1 is a perspective view of a first embodiment of the worklight of the present disclosure;

FIG. 2 is a view of the worklight of FIG. 1 affixed to an object;

FIG. 3 is a second view of the worklight of FIG. 1 affixed to an object;

FIG. 4 is a side perspective view of the worklight of FIG. 1;

FIG. 5 is a second side perspective view of the worklight of FIG. 1;

FIG. 6 is a close-up view of a second embodiment of the worklight of the present disclosure;

FIG. 7 is a perspective view of a third embodiment of the worklight of the present disclosure;

FIG. 8 is a view of the worklight of FIG. 7 affixed to an object;

FIG. 9 is a second perspective view of worklight of FIG. 7; and

FIG. 10 is a close-up perspective view of the worklight of FIG. 7.

### DETAILED DESCRIPTION OF THE DISCLOSURE

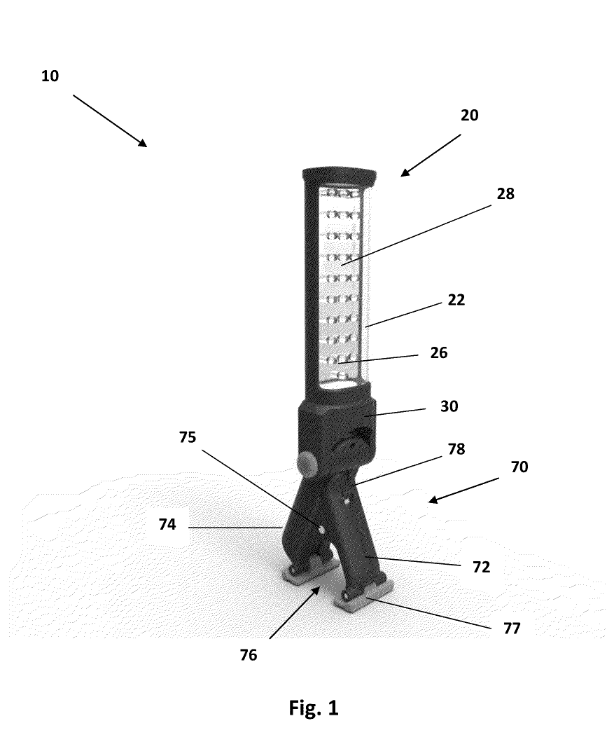

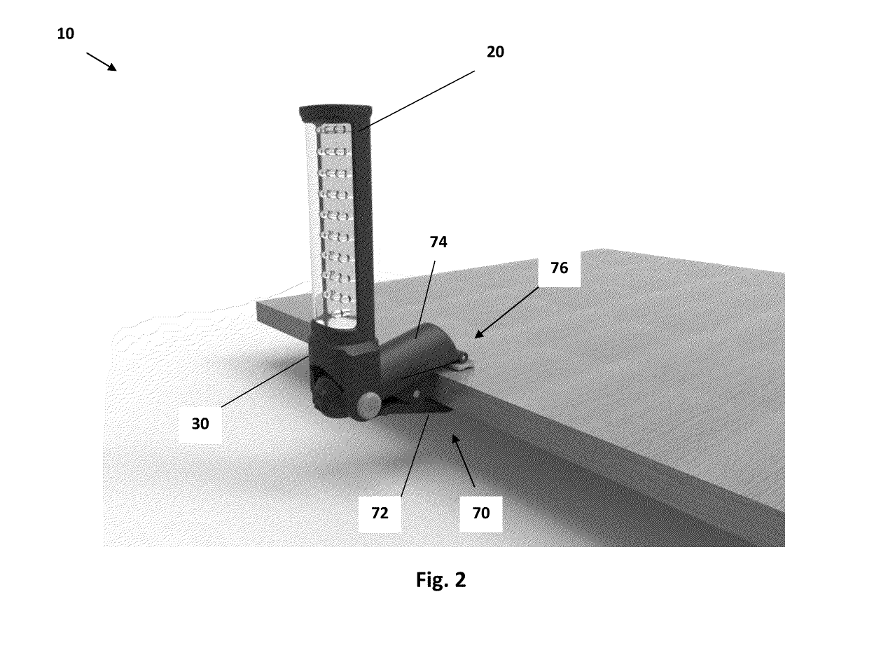

Referring to FIG. 1, worklight 10 of the present disclosure is shown. Worklight 10 has a head 20 and a handle 70. Handle 70 further comprises a first arm 72 and a second arm 74, which are mounted to each other in such a way as to be biased in a closed position (not shown). First arm 72 and second arm 74 can be gripped and squeezed together by a user, such that a clamp 76, defined by an end of first arm 72 and an end of second arm 74, opens, and can be attached to a fixed object as shown in FIG. 2. When clamp 76 is in its closed position and not affixed to an object or mounting surface, first arm 72 and second arm 74 can be easily and comfortably held by a user, rendering worklight 10 portable. As discussed in greater detail below, head 20 can pivot and rotate with respect to handle 70.

The present disclosure thus provides a worklight 10, that a user can use in hands-free operation by connecting it to an object. Worklight 10 can also be manipulated to illuminate spaces in a variety of different angles and positions (by moving head 20). This is a marked difference from worklights of the prior art, which are typically fixed position, and limited in the types of surfaces to which they can attach. Worklight 10 can take advantage of many different kinds of mounting surfaces such as edges of tables or other flat surfaces, poles, piping, branches of trees, articles of clothing or backpacks, and the like.

Worklight 10 is also different than many flashlights in that, as discussed in greater detail below, it provides a large band of light, as opposed to a spot or focused beam. Being able to position head 20 of worklight 10 in a variety of angles is highly advantageous, especially given the wide array of light that head 20 provides. The slim profile and mobility of head 20 about several axes allows for it to be placed into tight spaces not achievable with other worklights. Even with this functionality, worklight 10 remains portable for the user. First arm 72 and second arm 74 can form a body for handle 70 that has rounded edges for an ergonomic design and comfortable gripping by a user. In another embodiment, one or both of first arm 72 and second arm 74 can be semi-circular, so that handle 70 can have a substantially cylindrical design when clamp 76 is in a closed position.

For ease of describing worklight 10, the words “front,” “back,” “top,” and “bottom” reference the depiction shown in FIG. 1, with worklight 10 standing upright, and with first arm 72 in front of second arm 74. These directional terms are used only for describing worklight 10, and are not meant to limit the interpretation of the features discussed below.

As previously discussed, first arm 72 and second arm 74 are biased into a closed position. A spring, actuator, or other device (not shown) can be placed between first arm 72 and second arm 74, to create tension between first arm 72 and second arm 74 and effect the bias. First arm 72, second arm 74, and the spring device can be connected to each other with a pivot pin 75 that travels through corresponding holes in first arm 72, second arm 74, the spring device, and spacers or covers that can be used to stabilize the spring device. At least one of first arm 72 and second arm 74 can have a plurality of textured or ridged overmolds (not shown) on a surface thereof, for easy gripping.

In one embodiment, the spring device is a torsion spring. The present disclosure, however, contemplates any devices that can create tension between first arm 72 and second arm 74, such as tension springs, extension springs, compression springs, integral plastic springs, wire or coil springs, and flat springs. These devices can be positioned around the axis of rotation of second arm 74, or in another location.

Head 20 has casing 22. In the shown embodiment, casing 22 is transparent, though the present disclosure contemplates tinted or frosted casings as well. Casing 22 surrounds and protects a light source 26. In the shown embodiment, light source 26 is a plurality of light-emitting diodes (LEDs). The present disclosure contemplates that other types of bulbs can be used, or that a single light source could replace the plurality of bulbs in light source 26.

Thus, when batteries or another power source are placed in electrical communication with light source 26, light is transmitted from bulbs 26 and out through casing 22, laterally to a main longitudinal axis of worklight 10. In the shown embodiment, casing 22 has a curved front that matches the shape of mount 30, so that they are flush with one another. The present disclosure contemplates other shapes for casing 22, such as arcuate, elliptical, parabolic, square, or rectangular. In the shown embodiment, panel 28, to which bulbs 26 are mounted, is a planar or flat surface. A rear surface of head 20 (not shown) may be flat or curved.

In other embodiments, panel 28 can be multi-faceted or -sided, or any of the other shapes discussed above with respect to casing 22. The LEDs of light source 26 can be arranged on the flat surface of panel 28, or on multiple sides if panel 28 is multi-faceted. As discussed above, casing 22 can be shaped so that it allows light to disperse out in multiple directions, for example perpendicular to the surface of panel 28.

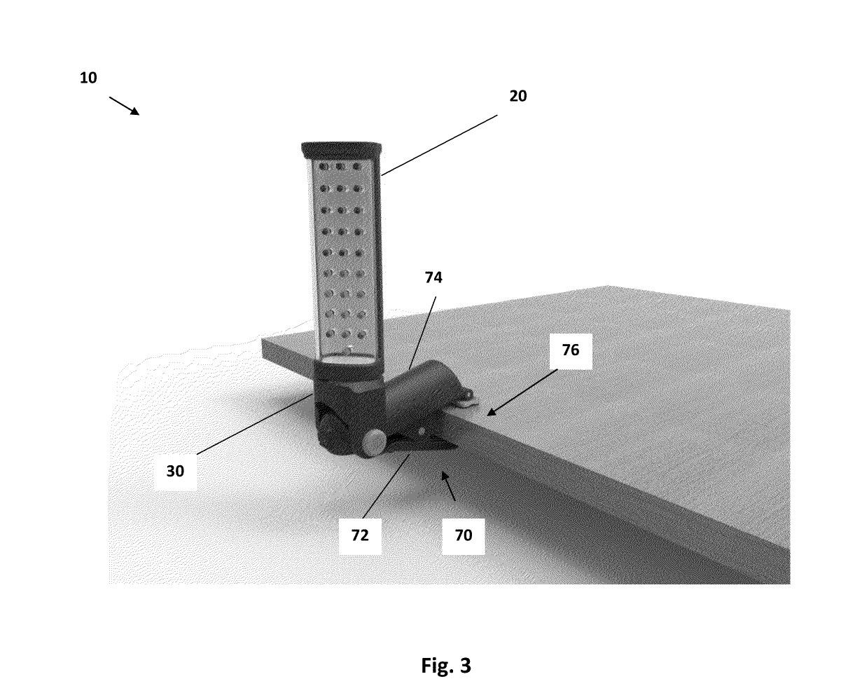

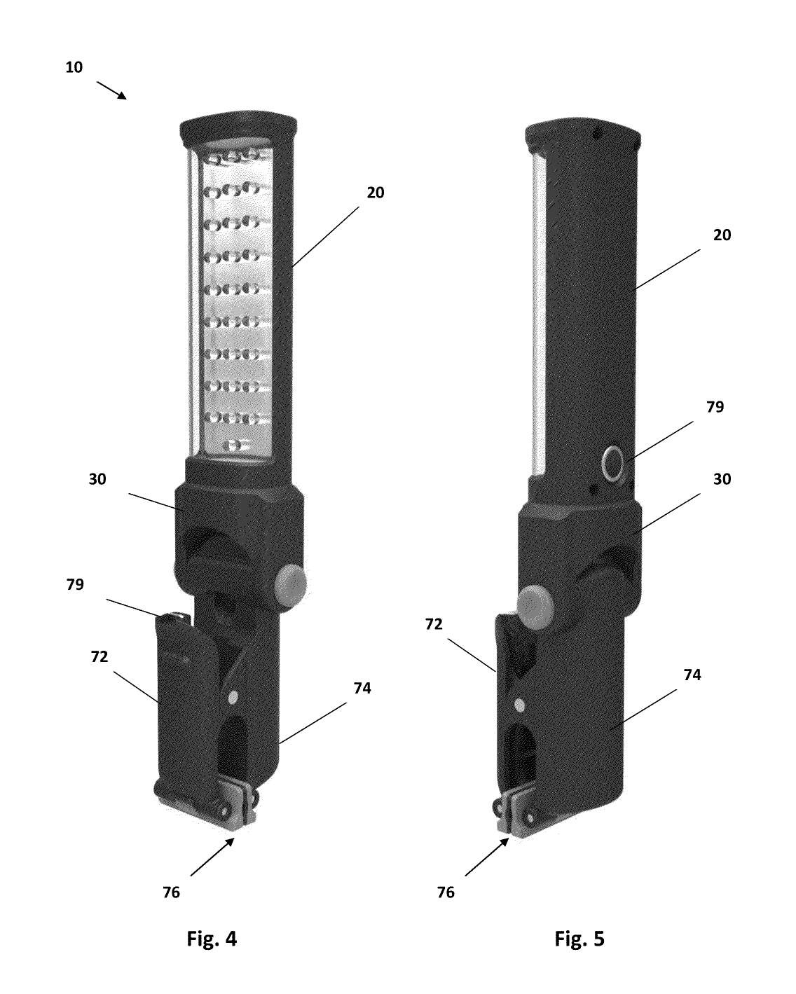

In the shown embodiment, head 20 is connected to mount 30, which is in turn connected to handle 70 so that mount 30 and head 20 can rotate about a horizontal axis passing through the top of handle 70. At least one of first arm 72 and second arm 74 are directly connected to mount 30. This allows a user of worklight 10 to move head 20 to a suitable position when clamp 76 is affixed to an object, as shown in FIGS. 2 and 3.

In addition, head 20 is connected to mount 30 so that it can rotate around a vertical axis of worklight 10, as is also shown in FIG. 3. In one embodiment, head 20 can rotate up to ninety degrees in either direction with respect to mount 30, or any subranges therebetween. As previously discussed, this is another highly advantageous feature of worklight 10 not seen in the prior art. Not only can worklight 10 be affixed to an object, but the user has the flexibility to adjust the angle of head 20 to provide maximum and optimal lighting. Other worklights do not have the option to adjust the angle of the head or light with respect to the worklight body.

There can be discrete stops for mount 30 (and thus head 20) along the arc of rotation, or mount 30 can be configured to be placed at any angle along the arc. There can be a suitable amount of friction between mount 30 and handle 70 to ensure that mount 30 stays in place when adjusted by the user. Mount 30 and handle 70 can be connected to each other with a pivot rod (not shown) that has button releases. Mount 30 will remain in a substantially rigid position until the user depresses the button releases. The user can then move head 20 into the desired location.

Light source 26 can be one light or a plurality of lights operating on the same circuit in communication with the batteries powering worklight 10. Alternatively, light source 26 can be a plurality of lights operating on at least two separate circuits. In the latter embodiment, one circuit can engage a portion of the bulbs in light source 26, and another circuit can engage a second portion of the bulbs in light source 26.

A switch 79 (e.g., toggle switch, button membrane, not shown) can be connected to or on first arm 72, second arm 74, mount 30, or head 20. In the shown embodiment (FIG. 5), switch 79 is on a rear surface of head 20. Through switch 79, the user can selectively place light source 26 located in electrical communication with batteries in a battery compartment (not shown). The battery compartment can be within any of first arm 72, second arm 74, mount 30, or head 20, or a combination thereof. Through switch 79, the user can select between a state in which all lights are off, all lights are on, or where selected lights are on while others remain off.

At least one of first arm 72 and second arm 74 can have a latch 78 at a top end thereof. The latch can have a front end that, when pushed in a forward direction by a user, engages a cavity in the other of first arm 72 or second arm 74, or mount 30. When the latch engages the cavity in this manner, clamp 76 remains in the open position, and worklight 10 can be placed on a surface, as shown in FIG. 1. This provides yet another mode of operation for worklight 10, in addition to those described above. The present disclosure also contemplates other methods for keeping clamp 76 in the open position. Clamp 76 can have feet 77 at the bottom thereof, to assist worklight 10 with standing on end as shown.

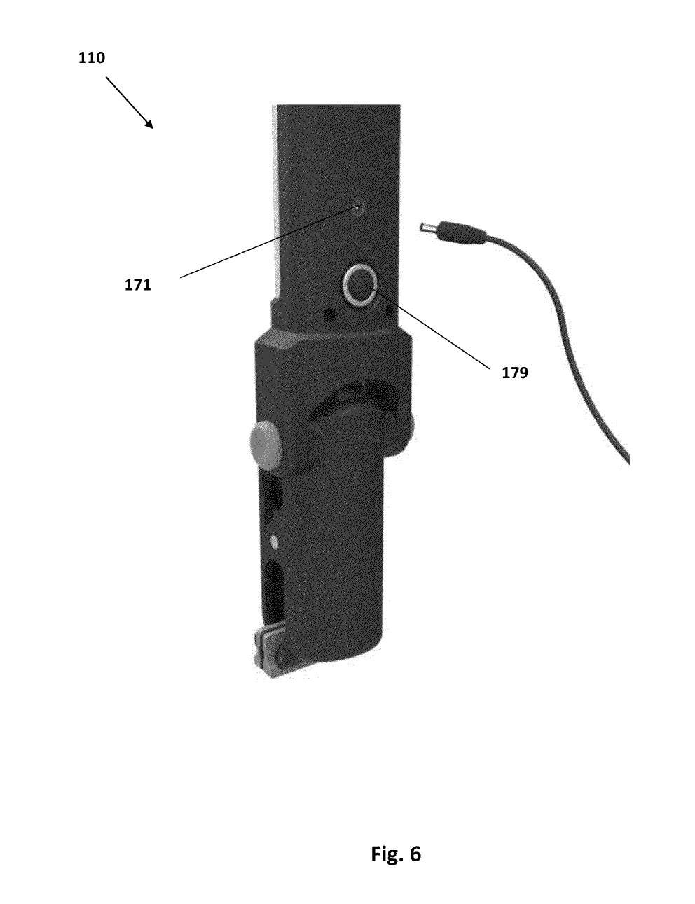

Referring to FIG. 6, a second embodiment of the worklight of the present disclosure is shown, and referred to by number 110. Worklight 110 functions in a similar manner to worklight 10, with the exception that worklight 110 has an outlet 171 for receiving a power cord. This power cord can charge rechargeable batteries (not shown) located within worklight 110. The rechargeable batteries can be within either of the clamp arms in light 210, the head, or the mount. A power switch 179 can turn the light source (not shown) in worklight 110 on and off.

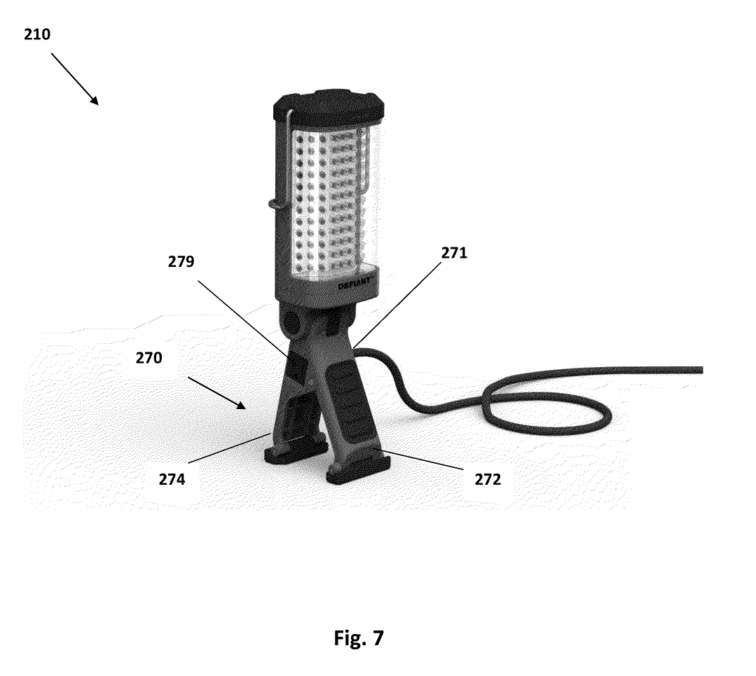

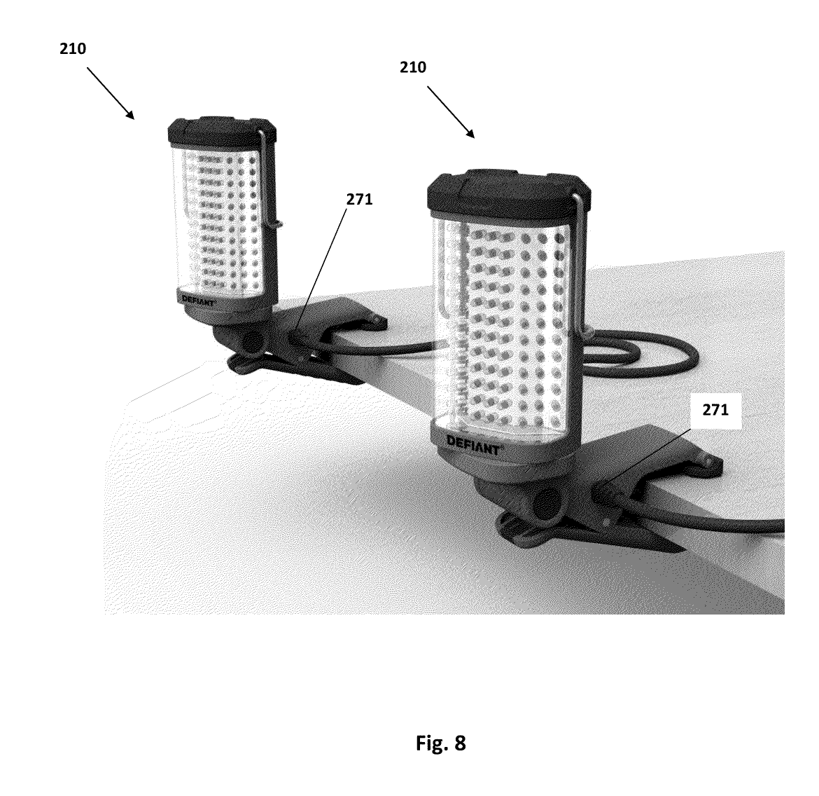

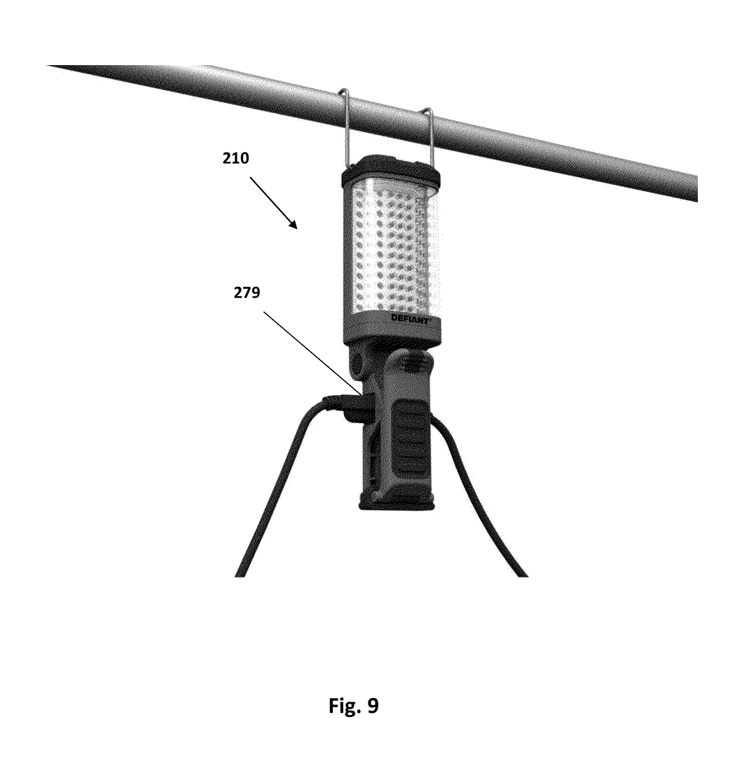

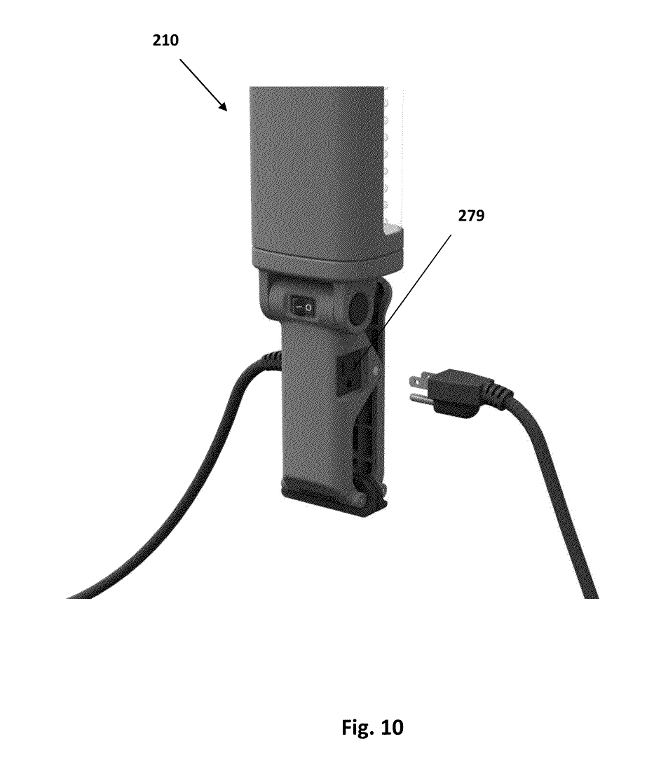

Referring to FIGS. 7 and 8, a third embodiment of the worklight of the present disclosure is shown, and referred to by numeral 210. Worklight 210 functions in a very similar manner worklights 10 and 110, with the exception that worklight 210 runs on power supplied from an external source, such as with an electrical cord. Accordingly, handle 270 has at least one port 271 on at least one of first arm 272 and second arm 274, for receiving the power cord (seen more clearly in FIG. 8). The power cord that feeds power to port 271 can either be permanently or removably connected to handle 270. In the embodiment shown in FIG. 7, there is also an outlet 179 on handle 170. As shown in FIGS. 9 and 10, worklight 210 can provide power to an external source when an additional power cord is plugged into outlet 279.

Any of the above described components can be made of materials such as acrylonitrile butadiene styrene (ABS), nylon, or other plastics, or can be made of cast or stamped metal.

Accordingly, worklights 10, 110, and 210 provide significant advantages in a variety of applications that currently available worklights cannot provide. For example, that head 20 bends to ninety degrees in each direction allows it to fit in tight spaces up inside an engine compartment of a vehicle, to get light where it is needed. The use of worklight 10 around the hoods of cars and undercarriages, with the various surfaces to clamp to, makes the clamp feature the best solution. Hooks, magnets, or plastic components to hang worklights are far less functional. Worklights are used for extensive periods of time, so being able to affix worklight 10 to a surface or stand and leave it on is ideal. Flashlights are typically used for much shorter immediate needs, where holding them for a short amount of time is not an issue. Another advantage to worklight 10 is presented dirty hands—worklight users may have oil, grease, paint, glue on their hands and can't keep holding lights or putting them in their mouth. Once the light is turned on, users need to be getting light where they want and not have to touch again versus flashlights. Worklight 10 provides advantages for all of these uses and more.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated for carrying out this disclosure, but that the disclosure will include all embodiments falling within the scope of the claims.

What is claimed is:

1. A worklight, comprising:
a head, said head comprising a casing and a light source within said casing;
a support member, wherein said head is rotatably connected to said mount; and
a clamp having one end rotatably connected to said mount, and an opposite end having a gripping portion.

2. The worklight of claim 1, wherein said head has a generally rectangular shape.

3. The worklight of claim 1, wherein said head further comprises a planar panel therein, wherein said planar panel has at least one flat surface, and wherein said light source is on said surface of said panel.

4. The worklight of claim 1, wherein said clamp has a first arm, and a second arm pivotably connected to said first arm, and wherein at least one of said first arm and said second arm is connected to said mount.

5. The worklight of claim 4, wherein said first arm and said second arm are bias mounted to each other, so that said clamp is inclined toward a closed position.

6. The worklight of claim 5, wherein said first arm and said second arm are biased together with a spring.

7. The worklight of claim 1, further comprising a battery compartment in at least one of said first clamp arm, said second clamp arm, said mount, and said head.

8. The worklight of claim 1, wherein said casing is at least partially transparent, so that said light source may transmit light therethrough.

9. The worklight of claim 1, wherein said casing is connected to said head so that it is flush with said mount.

10. The worklight of claim 1, wherein said light source is a plurality of bulbs.

11. The worklight of claim 4, wherein at least one of said first arm and said second arm has a latch thereon, wherein said latch connects to said mount, so that said clamp is in an open position.

12. The worklight of claim 1, further comprising an electrical port for receiving power from an external source.

13. The worklight of claim 1, wherein the worklight has a longitudinal axis and a second axis perpendicular to said longitudinal axis, wherein said head rotates about said longitudinal axis and said mount rotates about said second axis.
